(19) United States
(12) Patent Application Publication
(10) Pub. No.: US 2010/0248717 A1
(43) Pub. Date: Sep. 30, 2010

(54) METHOD AND APPARATUS FOR PROVIDING A NETWORK SEARCH PROCEDURE

(75) Inventor: Lauri Johannes Eerolainen, Salo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/664,831

(22) PCT Filed: Jun. 19, 2008
(86) PCT No.: PCT/IB08/52432

§ 371 Date: Jun. 2, 2010

Related U.S. Application Data
(60) Provisional application No. 60/944,996, filed on Jun. 19, 2007.

(51) Int. Cl. H04W 8/00

(52) U.S. Cl. 455/434

(57) ABSTRACT

An approach is provided for performing a cell search procedure. System information that specifies a list of cell identifiers of a wireless network is generated for transmission to a terminal. The list of cell identifiers is used for performing a cell search procedure within the wireless network.

### RELATED APPLICATIONS

This application claims the benefit of the earlier filing date under 35 U.S.C. §119(e) of U.S. Provisional Application Ser. No. 60/944,996 filed Jun. 19, 2007, entitled “Method and Apparatus for Providing a Network Search Procedure,” the entirety of which is incorporated herein by reference.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves efficiently searching for a mobile network to obtain connectivity. Traditional procedures can introduce significant delay before network connectivity can be obtained.

### SOME EXEMPLARY EMBODIMENTS

Therefore, there is a need for an approach for providing an efficient search mechanism for finding a network, such that the approach can co-exist with already developed standards and protocols.

According to one embodiment of the invention, a method comprises generating system information that specifies a list of cell identifiers of a wireless network for transmission to a terminal, wherein the list of cell identifiers is used for performing a cell search procedure within the wireless network.

According to another embodiment of the invention, an apparatus comprises logic configured to generate system information that specifies a list of cell identifiers of a wireless network for transmission to a terminal, wherein the list of cell identifiers is used for performing a cell search procedure within the wireless network.

According to another embodiment of the invention, an apparatus comprises means for generating system information that specifies a list of cell identifiers of a wireless network for transmission to a terminal, wherein the list of cell identifiers is used for performing a cell search procedure within the wireless network.

According to another embodiment of the invention, a method comprises receiving system information including a list of cell identifiers of a wireless network for conducting a cell search procedure. The method also comprises storing the list. Further, the method comprises comparing a new cell identifier with the cell identifiers of the list for further evaluation of a corresponding cell.

According to another embodiment of the invention, an apparatus comprises logic configured to receive system information including a list of cell identifiers of a wireless network for conducting a cell search procedure. The apparatus also comprises a memory configured to store the list, wherein the logic is further configured to compare a new cell identifier with the cell identifiers of the list for further evaluation of a corresponding cell.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of providing a cell search procedure, according to various embodiments of the invention;

FIG. 2 is a flowchart of an exemplary cell search procedure;

FIGS. 3A and 3B are, respectively, a flowchart of an exemplary cell search procedure and a diagram of an associated timeline of the cell search procedure;

FIG. 4 is a flowchart of a process for maintaining a list of cell identifiers, according to an exemplary embodiment;

FIGS. 5A and 5B are a flowchart of a cell search procedure, according to an exemplary embodiment;

FIGS. 6A-6D are diagrams of communication systems having exemplary long-term evolution (LTE) and E-UTRA (Evolved Universal Terrestrial Radio Access) architectures, in which the system of FIG. 1A can operate to provide resource allocation, according to various exemplary embodiments of the invention;

FIG. 7 is a diagram of hardware that can be used to implement an embodiment of the invention; and

FIG. 8 is a diagram of exemplary components of a user terminal configured to operate in the systems of FIGS. 6A-6D, according to an embodiment of the invention.

### DESCRIPTION OF PREFERRED EMBODIMENT

An apparatus, method, and software for providing a search procedure for a network are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless network compliant with the Third Generation Partnership Project (3GPP) Long Term Evolution (LTE) architecture, it is recognized by one of ordinary skill in the art that the embodiments of the inventions have applicability to any type of communication system and equivalent functional capabilities.

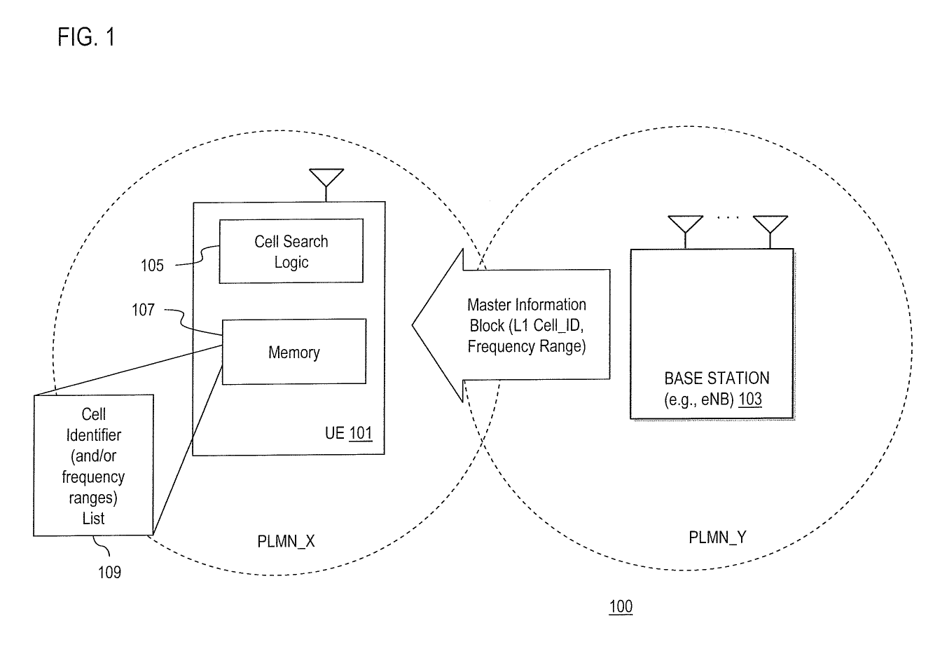

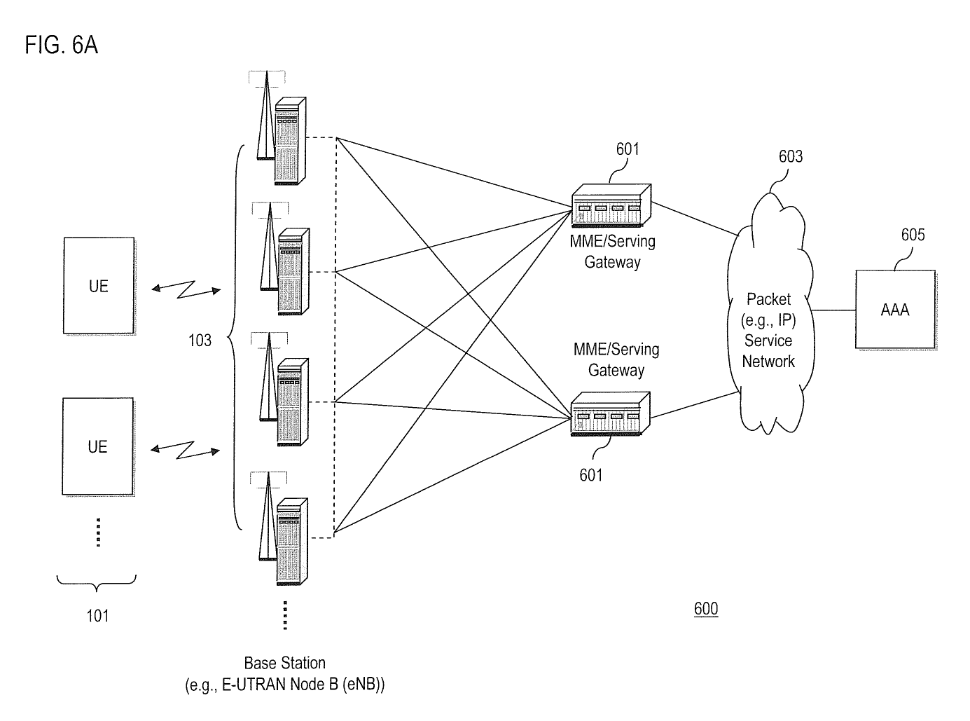

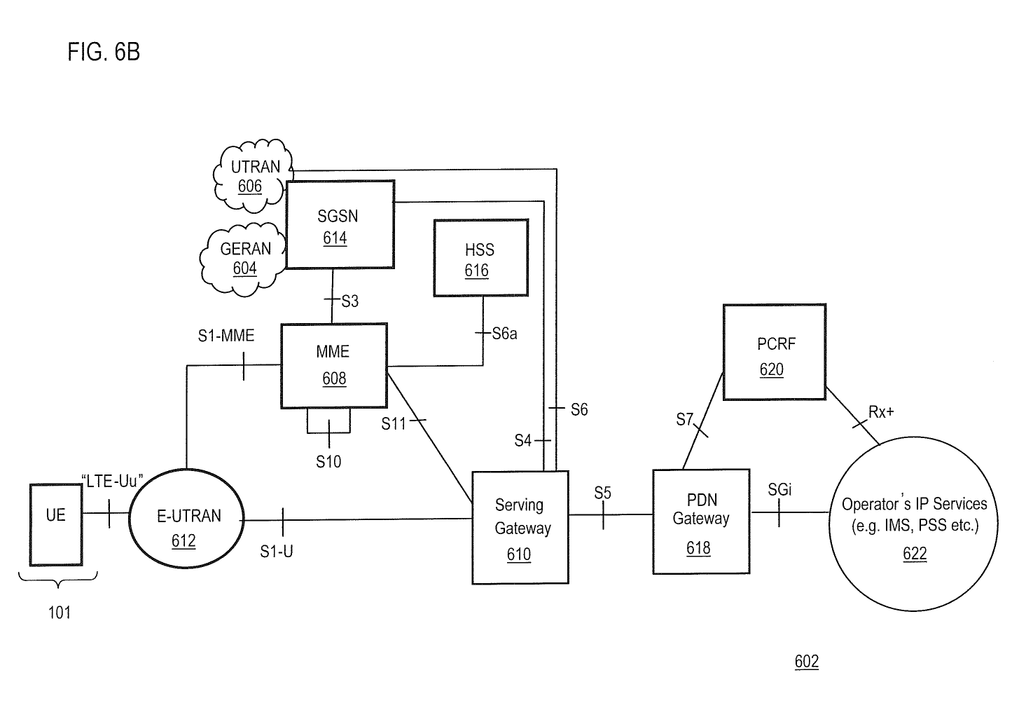

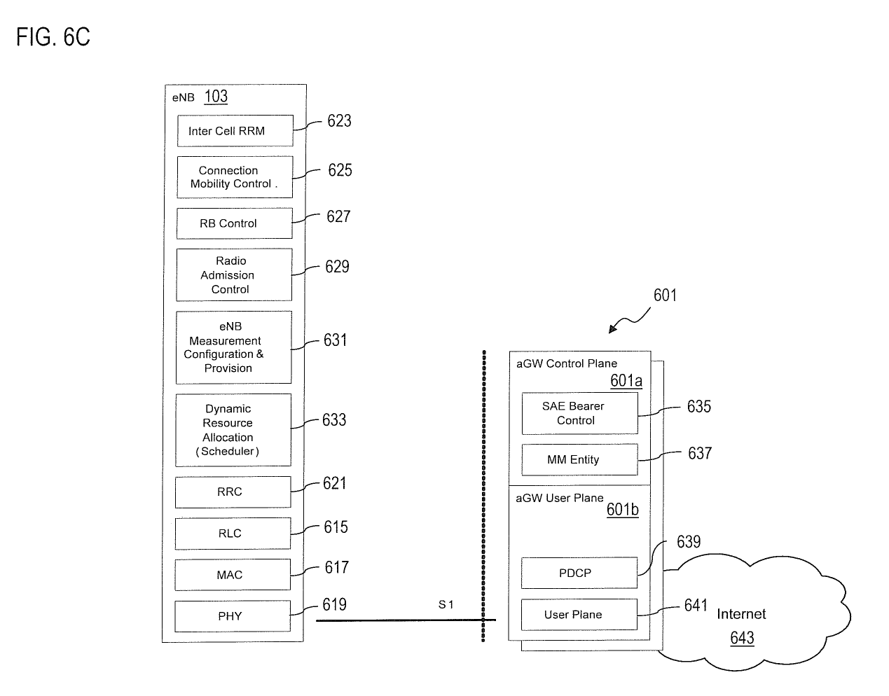

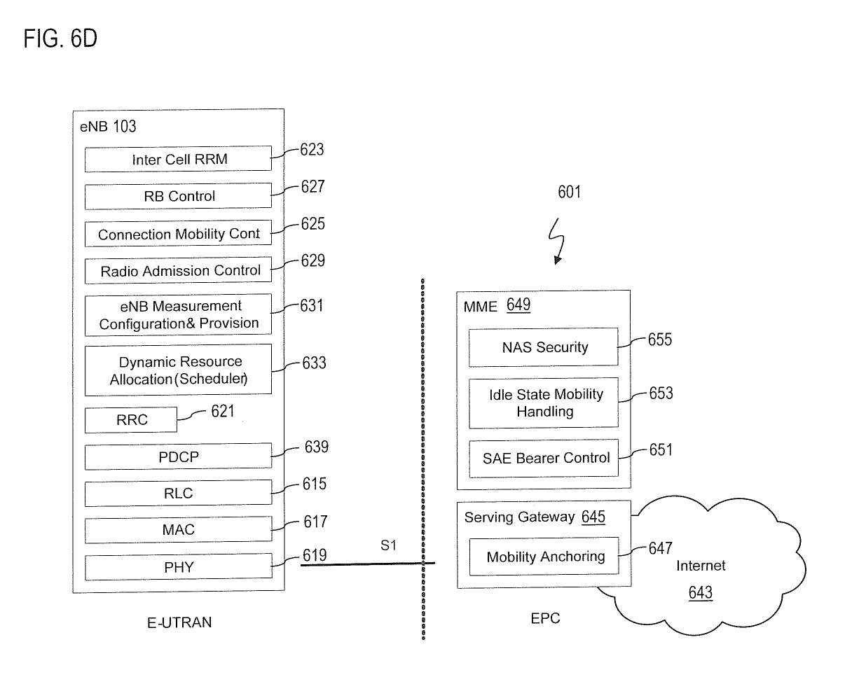

FIG. 1 is a diagram of a communication system capable of providing a cell search procedure, according to various embodiments of the invention. As shown in FIG. 1, one or more user equipment (UEs) 101 communicate with a base station 103, which is part of an access network (e.g., 3GPP LTE (or E-UTRAN), etc.). For example, under the 3GPP LTE architecture (as shown in FIGS. 6A-6D), the base station 103 is denoted as an enhanced Node B (eNB). The UE 101 can be any type of mobile stations, such as handsets, terminals, stations, units, devices, multimedia tablets, Internet nodes, communicators, Personal Digital Assistants (PDAs) or any type of interface to the user (such as “wearable” circuitry, etc.).

The base station 103a employs a transceiver (not shown) to exchange information with the UE 101a via one or more antennas, which transmits and receives electromagnetic signals. For instance, the base station 103 may utilize a Multiple Input Multiple Output (MIMO) antenna system for supporting the parallel transmission of independent data streams to achieve high data rates with the UE 101. The base station 103, in an exemplary embodiment, uses OFDM (Orthogonal Frequency Divisional Multiplexing) as a downlink (DL) transmission scheme and a single-carrier transmission (e.g., SC-FDMA (Single Carrier-Frequency Division Multiple Access) with cyclic prefix for the uplink (UL) transmission scheme. SC-FDMA can also be realized using a DFT-S-OFDM principle, which is detailed in 3GGP TR 25.814, entitled “Physical Layer Aspects for Evolved UTRA,” v.1.5.0, May 2006 (which is incorporated herein by reference in its entirety). SC-FDMA, also referred to as Multi-User-SC-FDMA, allows multiple users to transmit simultaneously on different sub-bands.

As shown, the user equipment (UE) 101 communicates with one or more mobile networks—e.g., a public land mobile networks (PLMNs), PLMN_X and PLMN_Y—as the UE 101 moves from one location to another. The UE 101 includes logic 105 for executing a cell search procedure to select a particular network and cell to operate within. To provide an efficient cell search procedure, the system 100 utilizes a list of cell identifiers (e.g., layer 1 (L1) cell ID numbers and optionally associated frequency range) corresponding to a particular mobile network; such a list is specified in a system information message (e.g., master information block (MIB)). The UE 101 need only read the MIB once per mobile network, wherein the list is stored in local memory 107 for later reference. Subsequently, the UE 101 can compare a new cell identifier to the stored list to determine whether to proceed further in evaluating the particular cell.

To better appreciate the efficiency of this arrangement, the general cell search procedure is explained below.

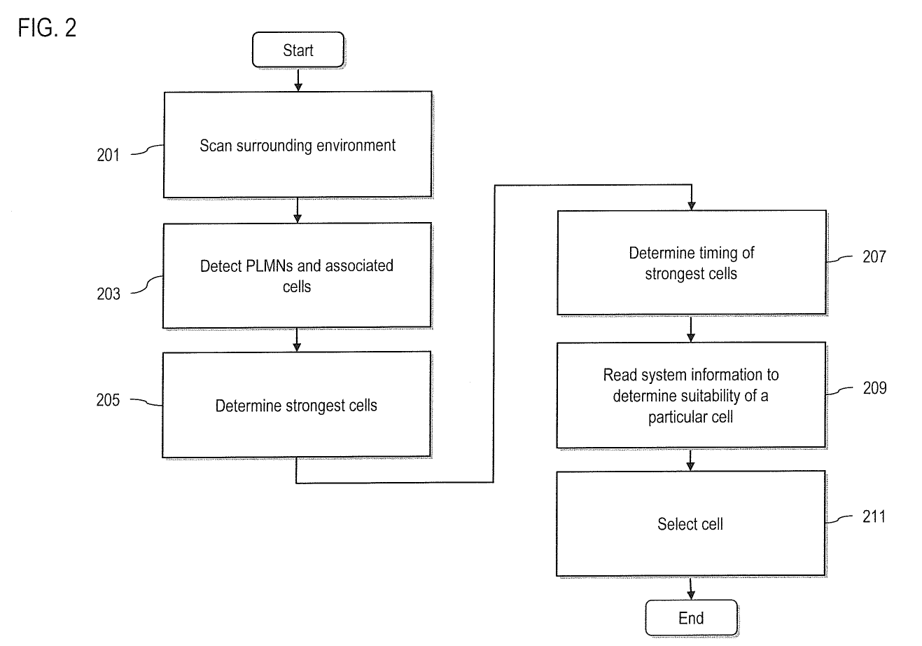

FIG. 2 is a flowchart of an exemplary cell search procedure. In a cell search procedure, the UE 101, per steps 201 and 203, basically scans and listens in the surrounding environment in order to find out which PLMNs and cells it can detect (i.e., “hear”). During the cell selection procedure, it is assumed the surrounding environment is static. The cell search procedure is typically used in the following scenarios: (1) cell selection: (after the UE 101 powers on or after cell lost); and (2) PLMN search after the UE 101 is already switched on (user triggered PLMN search or autonomous PLMN search like “home PLMN search”). Cell search involves determining the strongest cells, per step 205, and finding out timing of those cells (e.g., frame timing etc.), as in step 207. Also, the procedure entails reading system information data, per step 209, to determine suitability of the cell—e.g., determining whether the cell belongs to the correct network, whether the cell is barred, etc. Thereafter, the UE 101 selects an appropriate cell, per step 211.

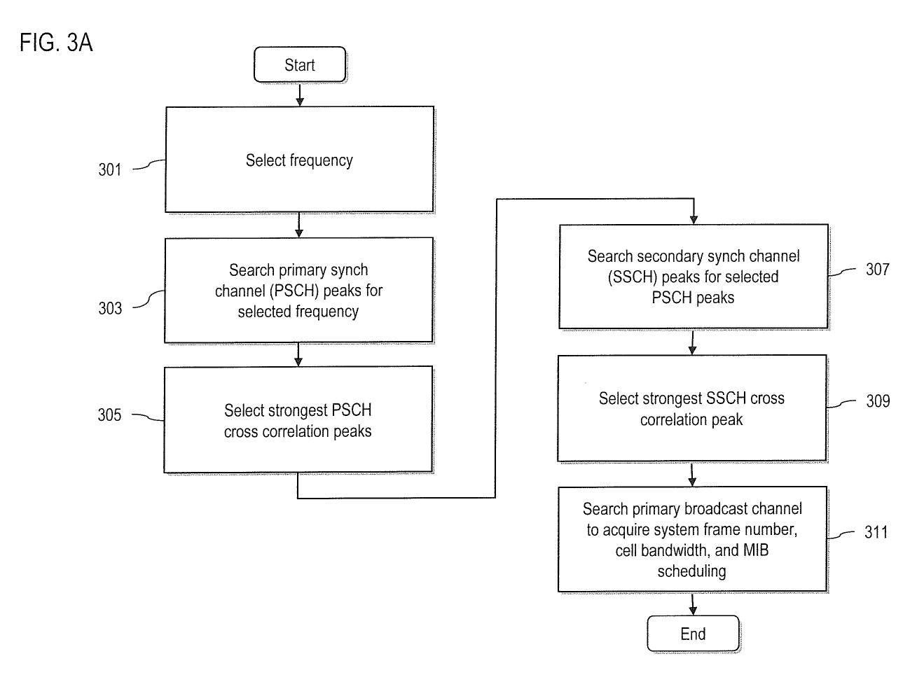

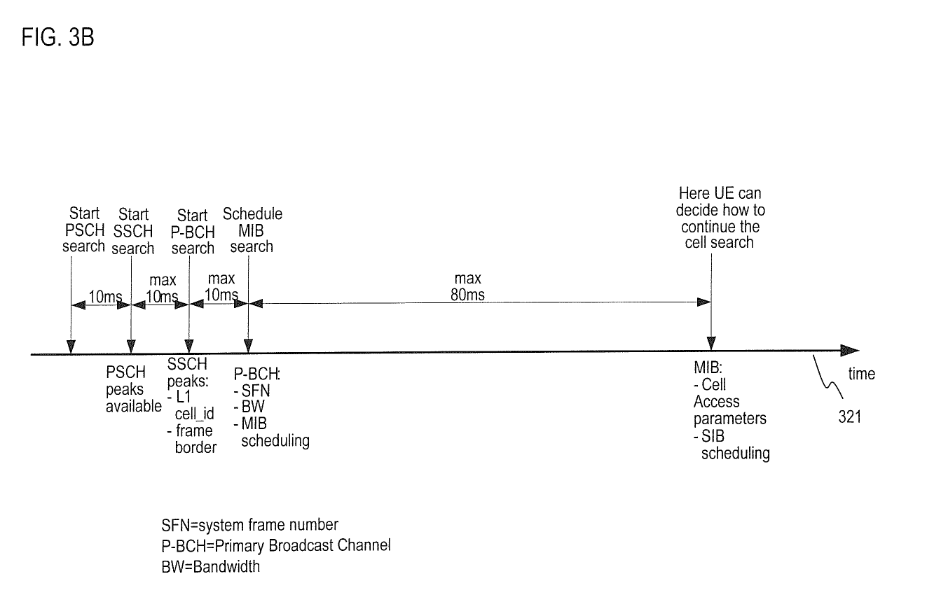

FIGS. 3A and 3B are, respectively, a flowchart of an exemplary cell search procedure and a diagram of an associated timeline of the cell search procedure. Specifically, FIG. 3A illustrates a cell search procedure utilized in an EUTRAN (Evolved Universal Terrestrial Radio Access Network) network. In EUTRAN, the cell search procedure is as follows. In step 301, the UE 101 selects a frequency (e.g., ˜max amount: 60 MHz/200 kHz=300 frequencies) to search. Alternatively, the channel raster can be 100 kHz (the frequency bands can be the same as in 3G); this requires more frequencies to be searched if a 2.1 GHz band (2.1 GHz band is ˜60 MHz wide) is used—i.e., 60 MHz/100 kHz=600 search frequencies. Next, the UE 101 searches, as in step 303, the PSCH (Primary Synchronization Channel) for peaks for the selected frequency; this phase can take about 10 ms. The strongest PSCH cross correlation peak is selected, per step 305, for further investigation.

Thereafter, in step 307, the UE 101 searches for peaks in the SSCH (Secondary Synchronization Channel) for the selected PSCH peak. This phase takes 5-10 ms. The strongest cross correlation SSCH peak is selected, per step 309. The SSCH evaluation also yields a L1 level cell ID value along with a frame border. After frame border is determined, the UE 101 can start a P-BCH (Primary Broadcast Channel) search, as in step 311. Under this scenario, the P-BCH is a very short system information “block” (SIB) (e.g., with size about 30 bits); this procedure is repeated every 10 ms. That is, P-BCH has a fixed allocation in time (repeated in every radio frame, i.e. 10 ms) and frequency domain (1.25 Mhz bandwidth).

Upon execution of the P-BCH search (e.g., max time for this process is 10 ms), the UE 101 has knowledge of the system frame number, cell bandwidth and MIB scheduling. MIB is a master information (system information) block that is repeated periodically, e.g., every 80 ms. After receiving MIB, the UE 101 can decide how to continue with cell search (e.g., by determining whether the cell belongs to the UE's own PLMN or not). This message can also include the scheduling information of SIB (secondary system information blocks).

As seen in FIG. 3B, a timeline 321 reveals how slow the search procedure can be. If the UE 101 must scan the whole band without finding a network, the waiting time for the MIB is longer. For instance, with 300 frequencies, the average wait time for the MIB is about 40 ms (max would be 80 ms). This results in about 12 seconds (300*40 ms). In another example, if 5% of the 600 carriers, for instance, would each result in 5 PSCH peaks, this would result in 150 possible cells, thereby yielding 6 seconds (150*40 ms) for the MIB.

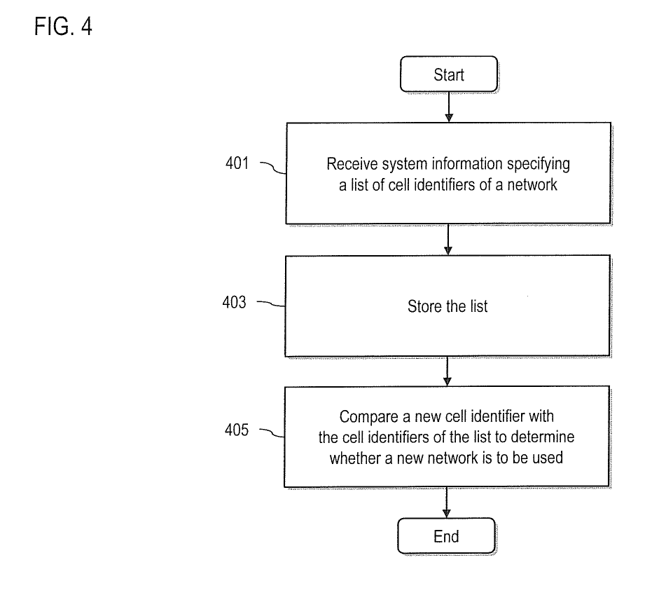

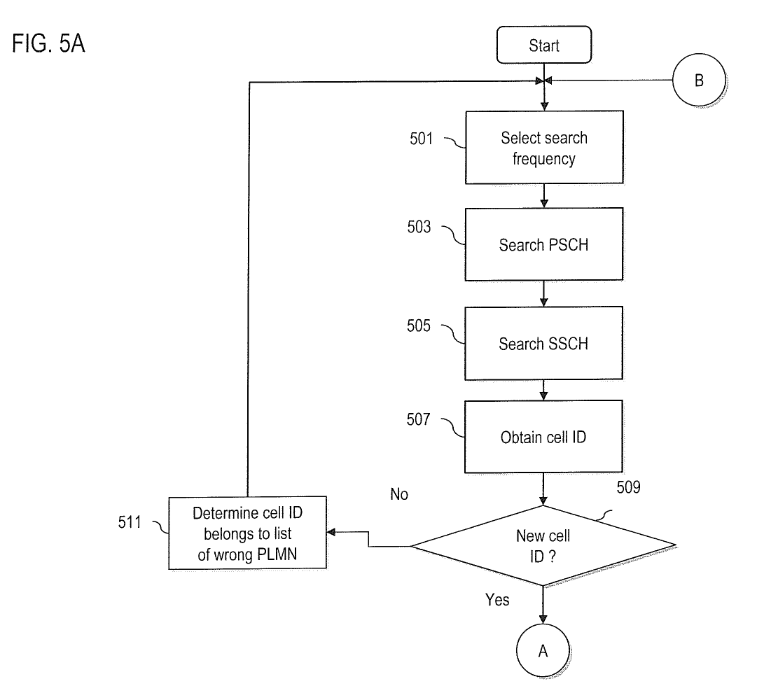

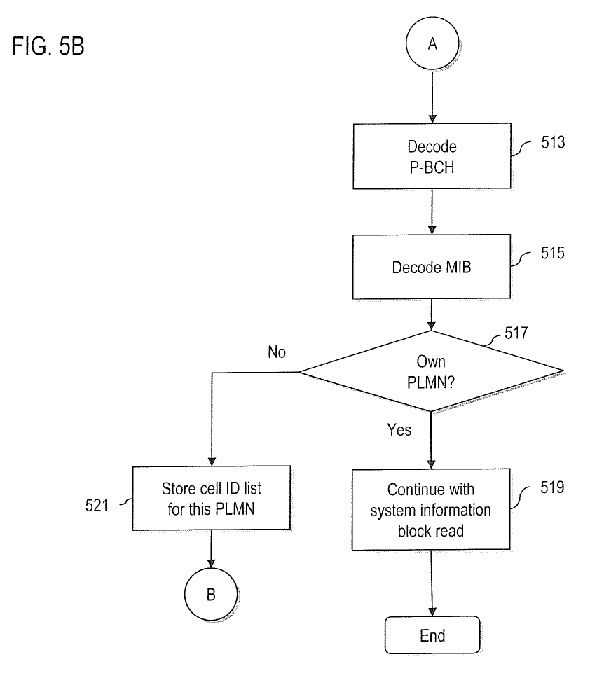

In recognition of the shortcomings of the above process, a list of cell IDs (and/or frequency ranges) is maintained by the UE 101, as next described with respect to FIGS. 4 and 5.

FIG. 4 is a flowchart of a process for maintaining a list of cell identifiers, according to an exemplary embodiment. This process is explained with respect to the system 100 of FIG. 1. In step 401, the UE 101 receives system information (e.g., MIB) specifying a list of cell identifiers of a network, such as PLMN_Y. The list is then stored within memory 107, per step 403. It is noted that the “list” can be stored using any type of data structure.

Subsequently, new cell identifiers (IDs) can be received. The cell search logic 105 can compare any new cell identifier with those in the list to determine whether a new network (e.g., PLMN_Y) is to be utilized, as in step 405.

This procedure can be applied to an EUTRAN environment, as illustrated in FIGS. 5A and 5B.

FIGS. 5A and 5B are a flowchart of a cell search procedure, according to an exemplary embodiment. As seen in FIG. 5A, the process begins with selection of a search frequency and performing a search of the PSCH peaks according to the selected frequency (steps 501 and 503). As with the process of FIG. 3A, searches for peaks in the SSCH is also performed for a selected PSCH peak (step 505). At this juncture, the P-BCH is searched to obtain, per step 507, system information (e.g., MIB). In one embodiment, a list of cell identifiers (e.g., L1 cell ID numbers—e.g., 0-511 in EUTRAN) and/or frequency range belonging to the particular PLMN is added to the MIB block. Accordingly, the UE 101 need only read the MIB once per PLMN. The UE 101 stores the list for later reference. It is noted, in one embodiment, that the stored “L1 cell id list” lifetime is only as long as the cell selection takes time.

As mentioned, in one embodiment, the cell ID list could optionally be added (or augmented) with frequency range. For example, if assuming three operators, A, B and C exist. In this situation, A could be allocated “L1 cell ID's” 1-50 and 200-220, and B could be allocated “L1 cell ID's” 51-150. Lastly, C could be allocated “L1 cell ID's” 151-199 and 221-300. It is contemplated that any designation for the frequency ranges can be used; e.g., operator A could indicate that ID's 1-50 are in frequency range1 and ID's 200-220 in frequency range2.

After obtaining this list, the UE 101 can readily compare a new L1 cell ID number (available after SSCH peak search) to the entries within the stored L1 cell ID list (step 509). Consequently, the UE 101 can determine whether a current cell evaluation can be cancelled and a new search frequency can be selected. If the cell ID is not new, the process determines that the cell ID belongs to a list of a “wrong” PLMN (step 511). However, if the cell ID is new, the P-BCH is decoded to obtain the MIB (step 513); the MIB is then decoded, as in step 515.

In step 517, the process determines whether the cell ID is associated with the UE's own PLMN. If so, the process continues to read the system information, per step 519. However, if not, the UE 101 stores the cell ID list for this particular PLMN (step 521).

Under the above approach, search time reduction is achieved in long search cases. For example, with 10 operators, and assuming that none of those are associated with the PLMN, this would mean that the MIB need only be decoded 10 times as opposed to 300. This can result in a substantial time savings, e.g., 11 seconds.

Accordingly, cell search time domain optimization can be performed using certain embodiments, without complex software design for search scheduling (as would be required in traditional procedure) stemming from the long idle time for the MIBs.

As mentioned, other wireless systems can be utilized, such as 3GPP LTE. Details of such a network architecture is provided as follows.

FIGS. 6A-6D are diagrams of communication systems having exemplary long-term evolution (LTE) architectures, in which the user equipment (UE) and the base station of FIG. 1 can operate, according to various exemplary embodiments of the invention. By way of example (shown in FIG. 6A), a base station (e.g., destination node) and a user equipment (UE) (e.g., source node) can communicate in system 600 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both uplink and downlink can utilize WCDMA. In another exemplary embodiment, uplink utilizes SC-FDMA, while downlink utilizes OFDMA.

The communication system 600 is compliant with 3GPP LTE, entitled “Long Term Evolution of the 3GPP Radio Technology” (which is incorporated herein by reference in its entirety). As shown in FIG. 6A, one or more user equipment (UEs) communicate with a network equipment, such as a base station 103, which is part of an access network (e.g., WiMAX (Worldwide Interoperability for Microwave Access), 3GPP LTE (or E-UTRAN), etc.). Under the 3GPP LTE architecture, base station 103 is denoted as an enhanced Node B (eNB).

MME (Mobile Management Entity)/Serving Gateways 601 are connected to the eNBs 103 in a full or partial mesh configuration using tunneling over a packet transport network (e.g., Internet Protocol (IP) network) 603. Exemplary functions of the MME/Serving GW 601 include distribution of paging messages to the eNBs 103, termination of U-plane packets for paging reasons, and switching of U-plane for support of UE mobility. Since the GWs 601 serve as a gateway to external networks, e.g., the Internet or private networks 603, the GWs 601 include an Access, Authorization and Accounting system (AAA) 605 to securely determine the identity and privileges of a user and to track each user's activities. Namely, the MME Serving Gateway 601 is the key control-node for the LTE access-network and is responsible for idle mode UE tracking and paging procedure including retransmissions. Also, the MME 601 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 6B, a communication system 602 supports GERAN (GSM/EDGE radio access) 604, and UTRAN 606 based access networks, E-UTRAN 612 and non-3GPP (not shown) based access networks, and is more fully described in TR 23.882, which is incorporated herein by reference in its entirety. A key feature of this system is the separation of the network entity that performs control-plane functionality (MME 608) from the network entity that performs bearer-plane functionality (Serving Gateway 610) with a well defined open interface between them S11. Since E-UTRAN 612 provides higher bandwidths to enable new services as well as to improve existing ones, separation of MME 608 from Serving Gateway 610 implies that Serving Gateway 610 can be based on a platform optimized for signaling transactions. This scheme enables selection of more cost-effective platforms for, as well as independent scaling of, each of these two elements. Service providers can also select optimized topological locations of Serving Gateways 610 within the network independent of the locations of MMEs 608 in order to reduce optimized bandwidth latencies and avoid concentrated points of failure.

As seen in FIG. 6B, the E-UTRAN (e.g., eNB) 612 interfaces with UE 101 via LTE-Uu. The E-UTRAN 612 supports LTE air interface and includes functions for radio resource control (RRC) functionality corresponding to the control plane MME 608. The E-UTRAN 612 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 608, as a key control node, is responsible for managing mobility UE identifies and security parameters and paging procedure including retransmissions. The MME 608 is involved in the bearer activation/deactivation process and is also responsible for choosing Serving Gateway 610 for the UE 101. MME 608 functions include Non Access Stratum (NAS) signaling and related security. MME 608 checks the authorization of the UE 101 to camp on the service provider's Public Land Mobile Network (PLMN) and enforces UE 101 roaming restrictions. The MME 608 also provides the control plane function for mobility between LTE and 2G/3G access networks with the S3 interface terminating at the MME 608 from the SGSN (Serving GPRS Support Node) 614.

The SGSN 614 is responsible for the delivery of data packets from and to the mobile stations within its geographical service area. Its tasks include packet routing and transfer, mobility management, logical link management, and authentication and charging functions. The S6a interface enables transfer of subscription and authentication data for authenticating/authorizing user access to the evolved system (AAA interface) between MME 608 and HSS (Home Subscriber Server) 616. The S10 interface between MMEs 608 provides MME relocation and MME 608 to MME 608 information transfer. The Serving Gateway 610 is the node that terminates the interface towards the E-UTRAN 612 via S1-U.

The S1-U interface provides a per bearer user plane tunneling between the E-UTRAN 612 and Serving Gateway 610. It contains support for path switching during handover between eNBs 103. The S4 interface provides the user plane with related control and mobility support between SGSN 614 and the 3GPP Anchor function of Serving Gateway 610.

The S12 is an interface between UTRAN 606 and Serving Gateway 610. Packet Data Network (PDN) Gateway 618 provides connectivity to the UE 101 to external packet data networks by being the point of exit and entry of traffic for the UE 101. The PDN Gateway 618 performs policy enforcement, packet filtering for each user, charging support, lawful interception and packet screening. Another role of the PDN Gateway 618 is to act as the anchor for mobility between 3GPP and non-3GPP technologies such as WiMax and 3GPP2 (CDMA 1× and EvDO (Evolution Data Only)).

The S7 interface provides transfer of QoS policy and charging rules from PCRF (Policy and Charging Role Function) 620 to Policy and Charging Enforcement Function (PCEF) in the PDN Gateway 618. The SGi interface is the interface between the PDN Gateway and the operator's IP services including packet data network 622. Packet data network 622 may be an operator external public or private packet data network or an intra operator packet data network, e.g., for provision of IMS (IP Multimedia Subsystem) services. Rx+ is the interface between the PCRF and the packet data network 622.

As seen in FIG. 6C, the eNB 103 utilizes an E-UTRA (Evolved Universal Terrestrial Radio Access) (user plane, e.g., RLC (Radio Link Control) 615, MAC (Media Access Control) 617, and PHY (Physical) 619, as well as a control plane (e.g., RRC 621)). The eNB 103 also includes the following functions: Inter Cell RRM (Radio Resource Management) 623, Connection Mobility Control 625, RB (Radio Bearer) Control 627, Radio Admission Control 629, eNB Measurement Configuration and Provision 631, and Dynamic Resource Allocation (Scheduler) 633.

The eNB 103 communicates with the aGW 601 (Access Gateway) via an S1 interface. The aGW 601 includes a User Plane 601a and a Control plane 601b. The control plane 601b provides the following components: SAE (System Architecture Evolution) Bearer Control 635 and MM (Mobile Management) Entity 637. The user plane 601b includes a PDCP (Packet Data Convergence Protocol) 639 and a user plane functions 641. It is noted that the functionality of the aGW 601 can also be provided by a combination of a serving gateway (SGW) and a packet data network (PDN) GW. The aGW 601 can also interface with a packet network, such as the Internet 643.

In an alternative embodiment, as shown in FIG. 6D, the PDCP (Packet Data Convergence Protocol) functionality can reside in the eNB 103 rather than the GW 601. Other than this PDCP capability, the eNB functions of FIG. 6C are also provided in this architecture.

In the system of FIG. 6D, a functional split between E-UTRAN and EPC (Evolved Packet Core) is provided. In this example, radio protocol architecture of E-UTRAN is provided for the user plane and the control plane. A more detailed description of the architecture is provided in 3GPP TS 86.300.

The eNB 103 interfaces via the S1 to the Serving Gateway 645, which includes a Mobility Anchoring function 647. According to this architecture, the MME (Mobility Management Entity) 649 provides SAE (System Architecture Evolution) Bearer Control 651, Idle State Mobility Handling 653, and NAS (Non-Access Stratum) Security 655.

One of ordinary skill in the art would recognize that the processes for performing cell searches may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

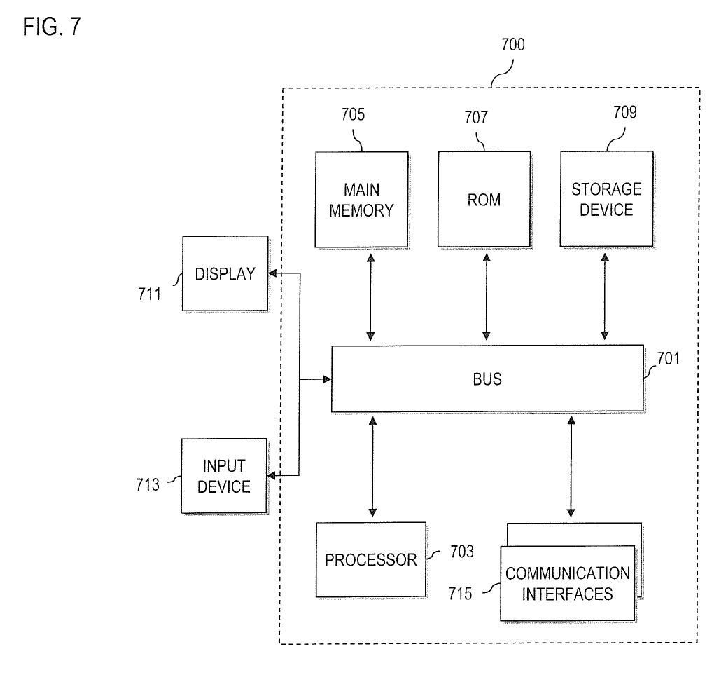

FIG. 7 illustrates exemplary hardware upon which various embodiments of the invention can be implemented. A computing system 700 includes a bus 701 or other communication mechanism for communicating information and a processor 703 coupled to the bus 701 for processing information. The computing system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computing system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computing system 700 may be coupled via the bus 701 to a display 711, such as a liquid crystal display, or active matrix display, for displaying information to a user. An input device 713, such as a keyboard including alphanumeric and other keys, may be coupled to the bus 701 for communicating information and command selections to the processor 703. The input device 713 can include a cursor control, such as a mouse, a trackball, or cursor direction keys, for communicating direction information and command selections to the processor 703 and for controlling cursor movement on the display 711.

According to various embodiments of the invention, the processes described herein can be provided by the computing system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 700 also includes at least one communication interface 715 coupled to bus 701. The communication interface 715 provides a two-way data communication coupling to a network link (not shown). The communication interface 715 sends and receives electrical, electromagnetic, or optical signals that carry digital data streams representing various types of information. Further, the communication interface 715 can include peripheral interface devices, such as a Universal Serial Bus (USB) interface, a PCMCIA (Personal Computer Memory Card International Association) interface, etc.

The processor 703 may execute the transmitted code while being received and/or store the code in the storage device 709, or other non-volatile storage for later execution. In this manner, the computing system 700 may obtain application code in the form of a carrier wave.

W The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

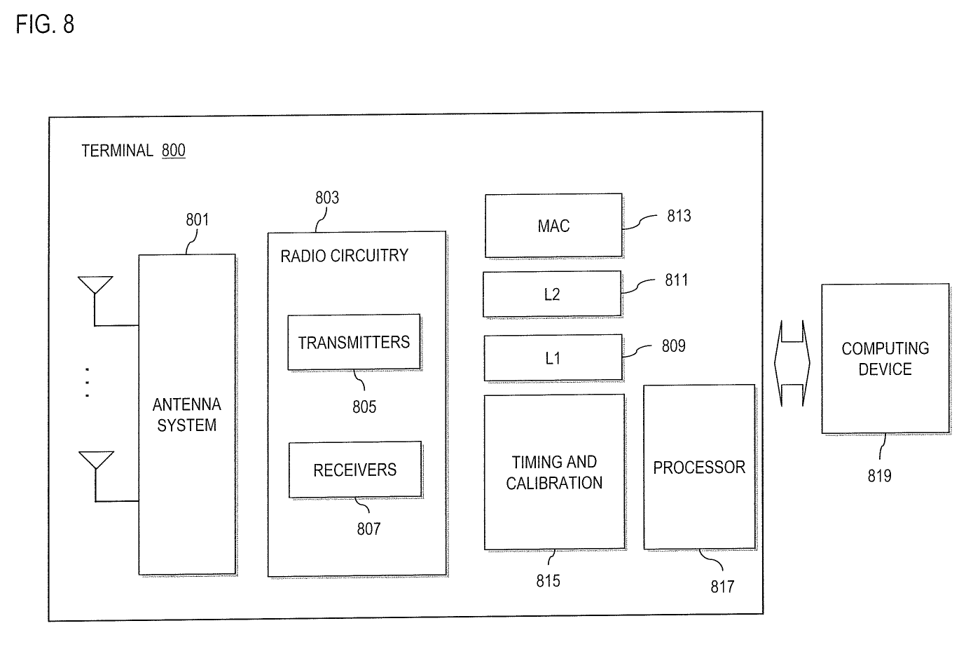

FIG. 8 is a diagram of exemplary components of a user terminal configured to operate in the systems of FIGS. 6A-6D, according to an embodiment of the invention. A user terminal 800 includes an antenna system 801 (which can utilize multiple antennas) to receive and transmit signals. The antenna system 801 is coupled to radio circuitry 803, which includes multiple transmitters 805 and receivers 807. The radio circuitry encompasses all of the Radio Frequency (RF) circuitry as well as base-band processing circuitry. As shown, layer-1 (L1) and layer-2 (L2) processing are provided by units 809 and 811, respectively. Optionally, layer-3 functions can be provided (not shown). Module 813 executes all Medium Access Control (MAC) layer functions. A timing and calibration module 815 maintains proper timing by interfacing, for example, an external timing reference (not shown). Additionally, a processor 817 is included. Under this scenario, the user terminal 800 communicates with a computing device 819, which can be a personal computer, work station, a Personal Digital Assistant (PDA), web appliance, cellular phone, etc.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
generating system information that specifies a list of cell identifiers of a wireless network for transmission to a terminal, wherein the list of cell identifiers is used for performing a cell search procedure within the wireless network.

2-26. (canceled)

27. A method according to claim 1, wherein the cell identifiers include layer (L1) level cell identifiers.

28. A method according to claim 1, wherein the list includes frequency ranges corresponding to the cell identifiers.

29. A method according to claim 1, further comprising:
selecting a search frequency; searching a primary synchronization channel for cross-correlation peaks associated with the selected search frequency; selecting the strongest one of the peaks; and
searching a secondary synchronization channel for cross-correlation peaks corresponding to the selected peak of the primary synchronization channel.

30. A method according to claim 1, further comprising:
receiving a cell identifier; comparing the received cell identifier with the entries of the list;
determining that the received cell identifier is new; and
decoding the system information based on the determination.

31. A computer-readable storage medium carrying one or more sequences of one or more instructions which, when executed by one or more processors, cause the one or more processors to perform the method of claim 1.

32. An apparatus comprising:
logic configured to generate system information that specifies a list of cell identifiers of a wireless network for transmission to a terminal, wherein the list of cell identifiers is used for performing a cell search procedure within the wireless network.

33. An apparatus according to claim 32, wherein the logic is further configured to select a search frequency and to search a primary synchronization channel for cross-correlation peaks associated with the selected search frequency, the logic being further configured to select the strongest one of the peaks and to search a secondary synchronization channel for cross-correlation peaks corresponding to the selected peak of the primary synchronization channel.

34. An apparatus according to claim 32, wherein the logic is further configured to receive a cell identifier, to compare the received cell identifier with the entries of the list, to determine that the received cell identifier is new, and to decode the system information based on the determination.

35. An apparatus comprising:
means for generating system information that specifies a list of cell identifiers of a wireless network for transmission to a terminal, wherein the list of cell identifiers is used for performing a cell search procedure within the wireless network.

36. An apparatus according to claim 35, further comprising:
means for selecting a search frequency;
means for searching a primary synchronization channel for cross-correlation peaks associated with the selected search frequency; means for selecting the strongest one of the peaks; and
means for searching a secondary synchronization channel for cross-correlation peaks corresponding to the selected peak of the primary synchronization channel.

37. An apparatus according to claim 35, further comprising:
means for receiving a cell identifier;
means for comparing the received cell identifier with the entries of the list;
means for determining that the received cell identifier is new; and
means for decoding the system information based on the determination.

38. A method comprising:
receiving system information including a list of cell identifiers of a wireless network for conducting a cell search procedure;
storing the list; and
comparing a new cell identifier with the cell identifiers of the list for further evaluation of a corresponding cell associated with the wireless network or another wireless network.

39. A computer-readable storage medium carrying one or more sequences of one or more instructions which, when executed by one or more processors, cause the one or more processors to perform the method of claim 38.

40. An apparatus comprising:
logic configured to receive system information including a list of cell identifiers of a wireless network for conducting a cell search procedure; and
a memory configured to store the list, wherein the logic is further configured to compare a new cell identifier with the cell identifiers of the list for further evaluation of a corresponding cell associated with the wireless network or another wireless network.
